(19) United States
(12) Patent Application Publication
(10) Pub. No.: US 2009/0079861 A1
(43) Pub. Date: Mar. 26, 2009

(54) Digital Camera with Interchangeable Lens and an Electronic Viewfinder

(76) Inventor: York Liao, Hong Kong (CN)

Correspondence Address: EAGLE IP LIMITED, 22/F., KWAI HUNG HOLDINGS CENTRE, 89 KING'S ROAD, NORTH POINT, HK

(21) Appl. No.: 11/859,796

(22) Filed: Sep. 24, 2007

(51) Int. Cl. G02B 27/10

(52) U.S. Cl. 348/341

(57) ABSTRACT

This invention provides an alternative to a digital single lens reflex camera, by not providing a through-the-lens optical image for the viewer to preview, while providing a high resolution through-the-lens electronic image that has a resolution equivalent to at least 200 dpi when seen by the viewer through the eyepiece, such that the viewer can preview the external image that he wishes to capture at a quality that is equivalent to an optical image, in the absence of any corresponding optical reflective element in the camera. The advantage of the present invention is that the quality of preview image is maintained while solving some of the problems in an OVF.

### FIELD OF INVENTION

This invention relates to a digital camera, in particular a digital camera with interchangeable lens and an electronic viewfinder.

### BACKGROUND OF INVENTION

In existing digital single lens reflex (DSLR) camera, a through-the-lens (TTL) optical viewfinder (OVF) is used for previewing, framing and focusing. In such a viewfinder, an optical preview image is reflected to a viewer using the focusing lens of the camera through a reflective flip mirror. The major components of a conceptual optical viewfinder in a DSLR camera are shown in FIG. 1a. A reflective flip mirror 28 is positioned inside the camera shell 48 along the optical axis 21 of the camera to reflect incident light from the focusing lens assembly 22 upward along the reflected optical axis 29. A focusing screen 30 is provided that is aligned to reflect optical axis 29 and is capable of showing a sharp frame if the image is focused. A condensing lens 32 is provided along reflected optical axis 29 to guide the light in the desired direction. A pentaprism 34 is provided behind condensing lens 32 to reflect the incident light to the correct orientation, that is, upright and not flipped horizontally. An eyepiece 36 is provided at the exit of pentaprism 34 to magnify the image. While such a viewfinder provides the best preview image quality, there are a few disadvantages. Firstly, when a viewer is capturing an image, reflective flip mirror 28 moves to an “up” (horizontal in most cameras) position as shown in FIG. 1b. Such movement invariably introduces vibration to image sensor array 42, causing the image being captured to become blurred. Furthermore, reflective flip mirror 28 also blocks viewer 40 from seeing the image when it is being taken. In sequential shooting, flip mirror 28 has to return to its “down” (i.e. normal) position between every shot to allow viewing. This is done at considerable mechanical challenge and the vibration it induces is more significant. Also, the speed of the flipping motion limits the maximum shooting frequency (expressed in frames per second or fps). Lastly, the entire viewfinder assembly is relatively bulky.

A prior art as shown in FIG. 2 has a beam-splitting prism 50 replacing reflective flip mirror 28. The function of beam-splitting prism 50 is to split focused light into two beams, one to viewer 40 and another to image sensor array 42. There is no moving part in the camera, and viewer 40 is always able to view the image through the viewfinder. However, as a substantial portion of the light intensity is diverted to the viewfinder, only a fraction of the incident light reaches the image sensor array 42 for picture taking, thus degrading the picture quality, especially when used in low light situations.

### SUMMARY OF INVENTION

Therefore, it is an object of the present invention to provide an alternative to a DSLR.

Accordingly, the present invention provides a digital camera with a lens module which focuses incident light from an external image to a focal plane. A microprocessor is provided for controlling the function of the camera. An image sensor array located at the focal plane is coupled to the microprocessor and includes a plurality of pixel elements. The image sensor array is capable of converting the incident light energy shone on the plurality of pixel elements to electrical signal. A high resolution display panel is coupled to the microprocessor and capable of receiving the electrical signal from the image sensor array and projecting an electronic image for a viewer to preview. An eyepiece is provided and is adapted to receive and magnify the projected electronic image to a viewer. The camera is designed such that it does not need any mechanism to produce a through-the-lens true optical image for the viewer to preview, yet is able to provide a high resolution through-the-lens electronic image that has a resolution equivalent to at least 200 dots per inch (dpi) when seen by the viewer through the eyepiece, such that the viewer can preview the external image that he wishes to capture at a quality that is equivalent to an optical image in the absence of any corresponding optical reflective element in the camera.

In one embodiment, the high-resolution viewfinder display panel is a liquid crystal display (LCD) panel. LCD display can achieve a higher spatial resolution than other displays, and is at a stage to meet the requirement of an electronic viewfinder with the desired spatial resolution output.

In another embodiment, the high-resolution viewfinder display panel is a black-and-white display panel. The image sensor array senses the image in color, and black-and-white information is extrapolated in the microprocessor and projected on the display panel.

In another embodiment, the lens module is interchangeable.

In another embodiment, resolution of the high-resolution viewfinder display panel can be changed depending on the mode of use. High resolution mode is only activated when the viewer is focusing, while low resolution mode is active at other times.

In yet another embodiment, the high-resolution viewfinder display panel can display the preview image in either color or black-and-white upon the viewer's choice. The resolution of the black-and-white mode is at least three times that of the color mode.

The present invention, which replaces the existing OVF systems with an electronic viewfinder (EVF), has many advantages over its optical counterpart. Firstly, the absence of reflective flip mirror 28 in the present invention means that there are no moving parts inside camera shell 48. This means no vibration is generated when a viewer is capturing an image. The vibration is associated with the flipping motion of reflective flip mirror 28 to let incoming light reach image sensor array 42. Since reflective flip mirror 28 is provided very close to image sensor array 42, the vibration is very likely to affect image sensor array 42. By eliminating the moving part and vibration, the EVF system is able to give a sharper captured image.

In addition, whereas reflective flip mirror 28 of existing TTL OVF system blocks the viewer's view each time an image is taken, the EVF system is able to give the viewer an uninterrupted preview of image. This is a big improvement when taking sequential shots. A continuous preview enables the viewer to track a target more effectively, especially for fast moving targets. It also eliminates the discomfort caused to the viewer from consecutive switches from seeing a preview image to seeing total darkness, which will be the case if each shot is taken by time exposure.

Further discussion about the advantages of the EVF system can be found in paragraph [0031] of the detailed description section, when the entire EVF system is described.

### BRIEF DESCRIPTION OF FIGURES

FIG. 1a is a ray diagram of a TTL OVF in a DSLR.

FIG. 1b is a ray diagram of the TTL OVF in FIG. 1a while capturing a photo.

FIG. 2 is a ray diagram of a prior art replacing the reflective flip mirror by a beam-splitting prism.

FIG. 3a is a side view of a preferred embodiment of the proposed invention.

FIG. 3b is a front view of the preferred embodiment in FIG. 3a.

FIG. 4 is a structural diagram of the preferred embodiment in FIG. 3a.

### DETAILED DESCRIPTION OF THE PREFERRED EMBODIMENTS

As used herein and in the claims, “comprising” means including the following elements but not excluding others. When interpreting each statement in this specification that includes the term “comprising”, features other than that or those prefaced by the term may also be present. Related terms such as “comprise” and “comprises” are to be interpreted in the same manner.

As used herein and in the claims, “couple” or “connect” refers to electrical coupling or connection either directly or indirectly via one or more electrical means unless otherwise stated.

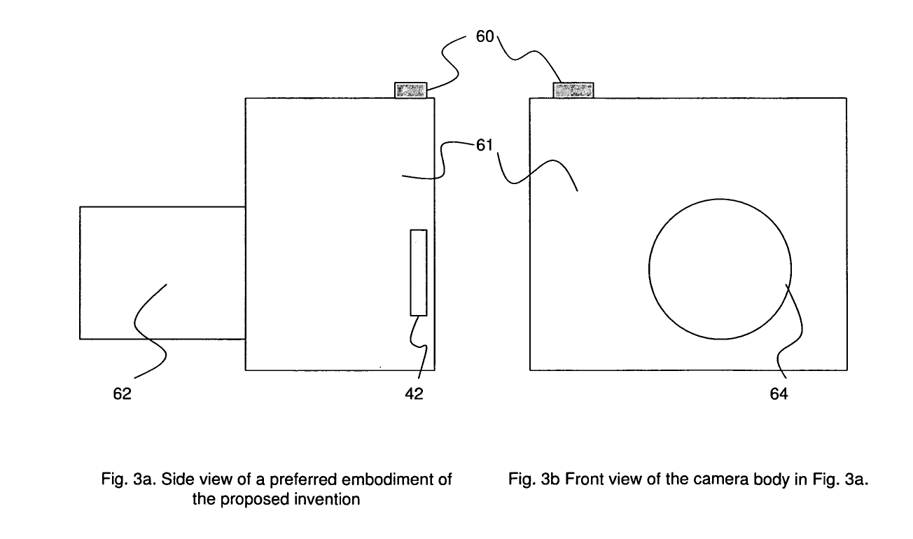

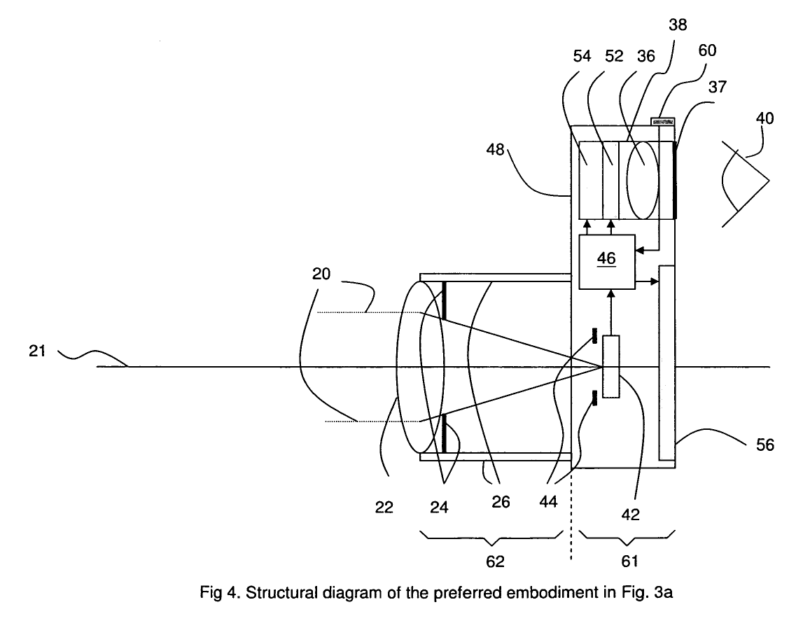

Referring now to the conceptual diagrams of the present invention as shown in FIGS. 3a and 3b, a preferred embodiment includes a camera body 61 and a lens module 62. Camera body 61 includes a camera shell 48 with a shutter button 60. There is a circular opening 64 at the front of the camera body 61 where lens module 62 can be mounted. An image sensor array 42 is mounted within the camera shell 48 towards the back and is concentric with circular opening 64. Camera body 61 may be configured to accept different lens module 62 with different characteristics, so long as lens module 62 can be mounted onto circular opening 64.

Refer now to a more detailed diagram of the present invention as shown in FIG. 4, a microprocessor 46 is coupled to the image sensor array 42 and shutter button 60. A main display panel 56 is coupled to microprocessor 46 and exposed to the exterior of the camera at the back to allow viewing of the image by the user. The spatial resolution of main display panel 56 is not high enough to be used for fine-focusing purposes. A focal plane shutter 44 is provided in front of image sensor array 42.

Lens module 62 includes a focusing lens assembly 22 attached to the front of camera shell 48 through a lens mount 26. Though only one lens is shown in this figure, focusing lens assembly 22 may comprise one or more lenses. Optical axis 21 runs through the center of focusing lens assembly 22 and the center of image sensor array 42, and the focal plane of focusing lens assembly 22 is aligned to the plane of image sensor array 42. An aperture 24 is attached inside lens mount 26, right behind focusing lens assembly 22.

Within the camera body 61, there is a viewfinder module. It comprises mainly a high-resolution viewfinder display panel 52 facing the back of the camera and coupled to microprocessor 46. A backlight 54 is provided behind high-resolution viewfinder display panel 52 coupled to microprocessor 46, and an eyepiece 36 is provided in front of high-resolution viewfinder display panel 52. A housing 38 encloses the electronic viewfinder module and a cover glass 37 covers the front of housing 38.

The operation of FIG. 4 is described below. When a viewer is focusing an image, incident light 20 strikes on focusing lens assembly 22, and focuses on image sensor array 42. Aperture 24 controls the amount of intensity entering the camera, and its size is controlled either by the viewer through a dial on the lens mount (not shown in figure) or by some well established auto-exposure control system. Photons impinged on image sensor array 42 is converted to a voltage and sent to microprocessor 46 continuously. Microprocessor 46 produces an electronic image on high-resolution viewfinder display panel 52 at a preview frequency, which is the frequency of display for the viewfinder, expressed in fps. Backlight 54 provides illumination to high-resolution viewfinder display panel 52, and in cases where the ambience is bright enough, backlight 54 can be turned off to further reduce power consumption. Eyepiece 36 magnifies the image projected on high-resolution viewfinder display panel 52 to viewer 40. Housing 38 and cover glass 37 and backlight 54 combine to form a sealed chamber so that dust and moisture can be prevented from entering high-resolution viewfinder display panel 52 and eyepiece 36. Main display panel 56 can also be used for focusing or framing, albeit on a much coarser scale.

In a preferred embodiment, mechanical focal plane shutter 44 is not present but all the other parts remain the same. When the viewer presses shutter button 60, image sensor array 42 will be charged up for a period of time controlled by microprocessor 46 through the viewer. This period of time together with the size of aperture 24 will determine the amount of light contributing to the image. After the charge-up period, image sensor array 42 will send the signal to microprocessor, and then revert to the preview frequency for the user to preview for next image. The preview frequency should be high enough for a human eye to perceive the displayed image as continuous, which is around 32 fps. The captured image can be shown on main LCD panel 56 to allow review or edit as desired.

In another embodiment, electronically controlled mechanical focal plane shutter 44 is implemented in lieu of a fully electronically activated sensor to control the exposure time, or the equivalent of a shutter speed in a conventional camera. The mechanical shutter has been adopted by quite a number of ordinary digital cameras. If it is to be used in the proposed invention as an option, the shutter will have to be open at all times except during the actual image capture at prescribed speed. Otherwise the viewer will be blocked of the preview image.

For fine-focusing and depth-of-field adjustment purposes, the display quality of this EVF should be equivalent to a true optical image seen by a viewer through a TTL OVF system. It is found that the resolution a viewer should see at the viewfinder should be better or equivalent to viewing the content of an A4-sized paper (8 inches×11.5 inches) at a distance of 18 inches from the viewer. This translates to a spatial resolution of at least 200 dots per inch (dpi). Assuming eyepiece 36 has a magnification factor of 15, this means a spatial resolution of at least 3000 dpi is needed for high-resolution viewfinder display panel 52. The total number of pixels for a black and while display panel will be of the order of 3 million. For a color display panel it will be 3 times that or of the order of 10 million pixels.

This display resolution is made possible, for example, by utilizing state-of-the-art liquid crystal display technology such as Liquid Crystal on Silicon (LCoS). LCD panels manufactured using this technology can achieve a spatial resolution above 3000 dpi. For example, in 2005 the Sony LCoS technology SXRD can display a resolution of 1920×1080 in a 0.78 inch active area, which amounts to a spatial resolution of about 3500 dpi.

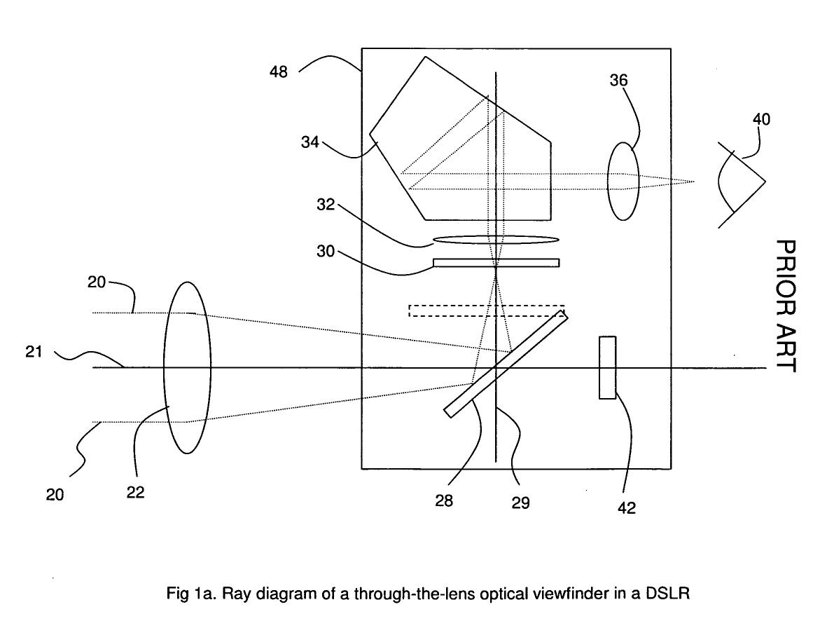

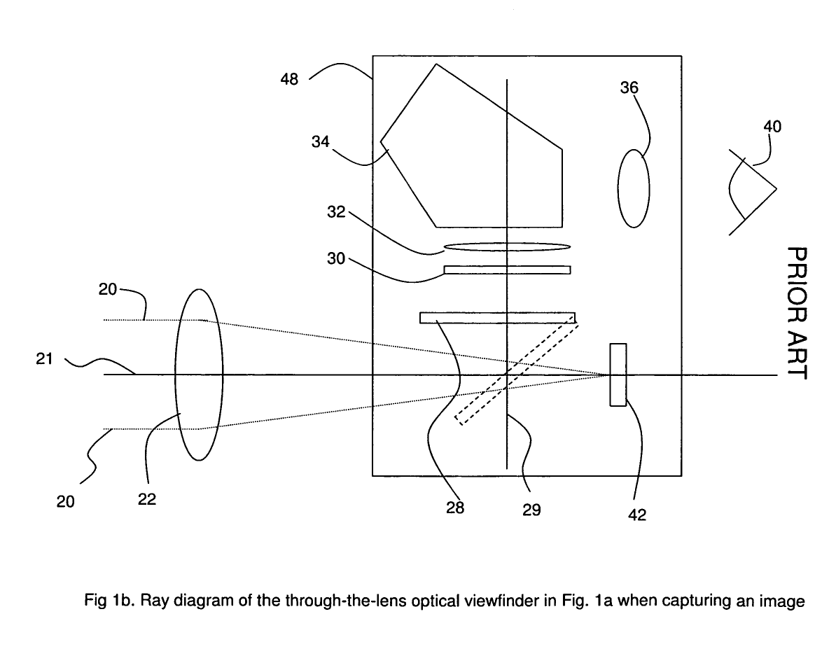

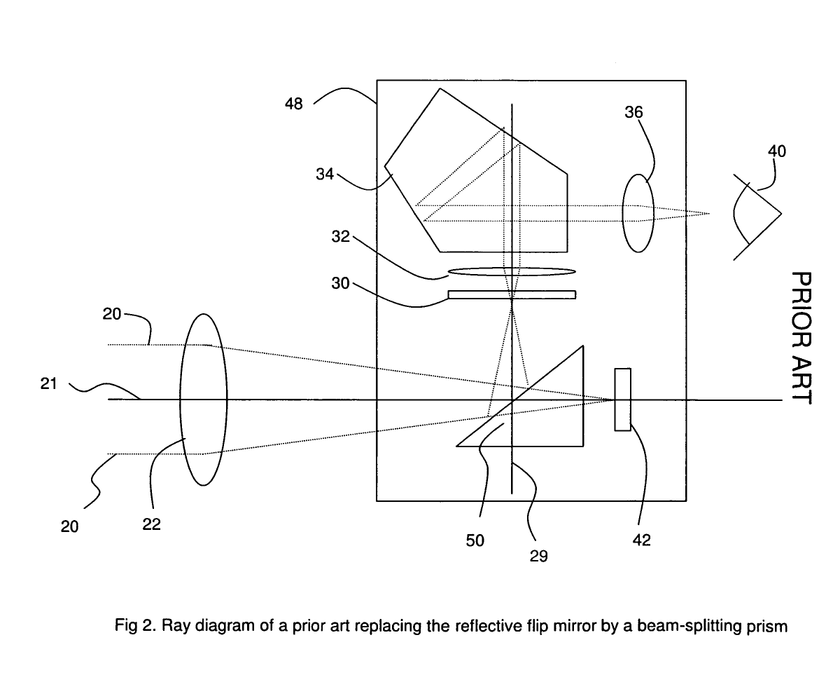

An added advantage of the EVF system over the OVF system can be seen by comparing a prior art camera (FIG. 1a) against a camera according to the present invention (FIG. 4). An OVF system occupies a significant portion of space inside camera shell 48, while the high-resolution viewfinder display panel 52, backlight 54 and eyepiece 36 can be packed much more tightly in an EVF. Moreover, the EVF system can be put anywhere inside the camera, since only electrical coupling is needed between image sensor array 42, microprocessor 46 and high-resolution viewfinder display panel 52. On the other hand, a TTL OVF system must have their components aligned along the optical axis of incident light or reflected light. Therefore, employing an EVF system makes a camera easier for manipulation. Furthermore, the absence of reflective flip mirror 28 reduces the minimum distance between image sensor array 42 and focusing lens assembly 22. That implies the viewing angle of the camera can be vastly increased.

It is observed that the most important factor in focusing is the sharpness of the preview image; and sharpness is determined by the number of pixels displaying the image. Moreover, it is found that color does not contribute any additional information for this purpose and hence a black-and-white viewfinder display suffices. As at least three pixel elements are required to display the three principle color components in a color LCD display, the spatial resolution of a color display panel is therefore three times lower than a corresponding black-and-white viewfinder display. Thus to achieve the same spatial resolution, the black-and-white LCD viewfinder display is a more cost-effective solution.

In a LCD black-and-white display, transmitted light is only attenuated by the crossed polarizers, while an additional two thirds of intensity is absorbed by each RGB color filter in a color display. Hence, a high luminance backlight is always required for color display. It is noted that the backlight is the most power consuming component in a digital camera. Therefore, a high luminance backlight leads to high power consumption and hence short battery life.

In an embodiment, the backlight can be switched on or off, depending on user command or environmental factors such as luminance of ambient light.

Another advantage about black-and-white is that algorithms to process the color information of an image are not needed. This results in a much faster response time, hence a higher frame rate for the viewfinder. It also reduces power consumption since less processing is required from the microprocessor. This is very important since a viewfinder is used much more often than the actual capturing of the image, thus reducing power consumption of the viewfinder has a significant impact on the time a battery can last. Hence in a preferred embodiment, a black-and-white LCD viewfinder display is employed.

In an even preferred embodiment, the LCD viewfinder display panel is configured so that the viewer can select different display resolution modes. Specifically, the LCD viewfinder display panel is set to a default low resolution mode to conserve electrical power. Only when the viewer wishes to focus on an object, the camera will switch to a high resolution mode.

In one embodiment, a resolution adjustment knob (not shown in FIG. 4) is used for this purpose. The viewer can turn the knob to select a high resolution mode every time he wants to perform fine-focusing on an object within the image. He can then turn the knob back to low resolution mode in order to preserve battery power.

In another embodiment, the high resolution mode is activated by half-pressing shutter button 60. As conventional digital camera usually activates the auto-focus function when shutter button 60 is half-pressed, this feature can also be used to switch the LCD viewfinder display panel to high-resolution mode. This gives the viewer both convenience in controlling the resolution and ease for activation.

The preferred embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, main display panel is not an essential component of some of the embodiments for the present invention because the conventional SLR camera provides an optical viewfinder for fine-focusing, whereas the present invention uses a high resolution electronic display panel for fine-focusing purposes. The electronic viewfinder can replace the main display panel without losing any focusing capabilities, and the viewer is still able to edit the captured image on the viewfinder if needed.

What is claimed is:

1. A digital camera comprising:
a) a lens module adapted to focus incident light from an external image to a focal plane;
b) a microprocessor for controlling the function of the camera;
c) an image sensor array coupled to said microprocessor and comprising a plurality of pixel elements located at said focal plane; said image sensor array capable of converting said incident light energy shone on said plurality of pixel elements to electrical signal;
d) a high resolution display panel coupled to said microprocessor and capable of receiving said electrical signal from said image sensor array and projecting an electronic image for a viewer to preview;
e) an eyepiece adapted to receive and magnify said projected electronic image to a viewer;
said camera characterized in that said camera does not provide any mechanism to produce a through-the-lens true optical image for said viewer to preview; said camera providing a high resolution through-the-lens electronic image that has a resolution equivalent to at least 200 dpi when seen by the viewer through said eyepiece, such that said viewer can preview said external image that he wishes to capture at a quality that is equivalent to an optical image, in the absence of any corresponding optical reflective element in said camera.

2. The digital camera according to claim 1, wherein said display panel is a liquid crystal display panel.

3. The digital camera according to claim 2, wherein said liquid crystal display panel is a black-and-white display panel.

4. The digital camera according to claim 1, further comprising a backlight for illuminating said display panel.

5. The digital camera according to claim 4, wherein said backlight is adapted to switch between an ON state and an OFF state, said backlight illuminating said display panel in said ON state but not illuminating said display panel in said OFF state.

6. The digital camera according to claim 5 wherein said backlight is switched to said ON state when the luminance of ambient light is below a specified threshold.

7. The digital camera according to claim 1, wherein said lens module is interchangeable.

8. The digital camera according to claim 1, whereby subject to said viewer's control, said plurality of pixel elements in said display panel can be selectively enabled or disabled; thus displaying said electronic image in a plurality of spatial resolution.

9. A method of reducing power consumption of a digital camera by alternating the spatial display resolution of an electronic image at the display panel of a viewfinder comprising the steps of:
a) displaying a low resolution electronic image onto said display panel so as to save electrical power; said low resolution electronic image generated by selectively enabling a portion of pixel elements of said display panel;
b) displaying a high resolution electronic image onto said display panel upon viewer's command, said high resolution electronic image generated by enabling all required said pixel elements of said display panel; and
c) reverting back to display said low resolution electronic image after said viewer releases said command.

10. The method according to claim 9, wherein said command is half-pressing a shutter button.

11. The method according to claim 10, wherein said command also activates auto-focus function of a camera.
